(19) United States
(12) Patent Application Publication
(10) Pub. No.: US 2026/0098157 A1
(43) Pub. Date: Apr. 9, 2026

(54) GLUE FOR BOARDS

(71) Applicant: UNILIN, BV, Wielsbeke (BE)

(72) Inventors: Koen NEL, Wielsbeke (BE); Kenny MOUTON, Wielsbeke (BE); Gertjan VANCOILLIE, Wielsbeke (BE)

(21) Appl. No.: 19/114,956

(22) PCT Filed: Oct. 5, 2023
(86) PCT No.: PCT/IB2023/060008

§ 371 Date: Mar. 25, 2025

(30) Foreign Application Priority Data
Oct. 14, 2022 (BE) 2022/5828

(51) Int. Cl. C08L 97/02; B27N 3/00; B27N 3/02; B27N 3/04

(52) U.S. Cl. CPC C08L 97/02; B27N 3/002; B27N 3/02; B27N 3/04; C08L 2205/03

(57) ABSTRACT

A board includes cellulose-containing materials, such as vegetable fibers and/or wood chips and/or wood pieces, and a cured glue that bonds these cellulose-containing materials to one another. The cured glue is obtained by the curing of a glue that is a combination of at least one protein-containing fraction and a second fraction. The second fraction has molecules selected from the list of: amino acids, peptides, polyamines comprising amino acids, polyamides comprising amino acids and polyimines, a method for making such boards, and a glue for such boards.

This invention relates to a board comprising cellulose-containing materials, such as vegetable fibres and/or wood chips and/or wood pieces, and a cured glue that bonds these cellulose-containing materials to one another, wherein the cured glue is obtained by the curing of a glue that is a combination of at least one protein-containing fraction and a second fraction. This invention also relates to a method for making such a board, a glue for such boards and a method for producing such glues.

This invention relates to boards comprising cellulose-containing materials. These cellulose-containing materials can comprise one or more of the following materials: wood fibres, wood chips, wood shavings, wood layers, flax fibres, bamboo fibres, hemp fibres, other vegetable fibres, wood waste originating from e.g. the recycling of for example particle boards/wood fibreboards, etc. These cellulose-containing materials can therefore for example be lignocellulose-containing materials. The boards are for example wood fibreboards, such as MDF-medium density fibreboard-and HDF-high density fibreboard-, other wood-based boards such as particle boards, OSB (oriented strand board), multiplex boards. Such boards are also referred to as derived wood products. The boards can also be non-wood-based fibreboards, such as flax boards, bamboo boards, hemp boards, etc. The above-mentioned boards may or may not be partially or completely formed from recycled material, such as recycled lignocellulose-containing material. For example, the cellulose-containing materials can comprise recycled materials originating from the recycling of for example particle boards, wood fibreboards or panels comprising such particle boards or wood fibreboards. This means that particle boards can comprise particles of recycled particle boards, or wood fibreboards can comprise particles of recycled wood fibreboards.

The most common glue used in the production of such boards is an aminoplast polymer produced via a polycondensation reaction from urea and formaldehyde and converted to a urea formaldehyde resin (UF resin). Optionally, melamine is added and a melamine urea formaldehyde resin (MUF resin) is obtained, or melamine and phenol are added (MUPF resins: melamine urea phenol formaldehyde). The major advantages of such glues are their low cost—because of the use of generally available and inexpensive raw materials in their preparation—, and their high reactivity. Such glues can emit formaldehyde during and after polymerisation under the influence of temperature, moisture, or pH modification. Efforts are increasingly being made in order to limit or even reduce to zero the emission of formaldehyde from boards. For this reason, formaldehyde-free glues for the production of the above-mentioned boards have been and are being sought.

US2006/0163769 describes the use of water glass as a glue in the production of derived wood products that are fire-resistant.

A known formaldehyde-free glue for use in the production of derived wood products is composed of polymeric methylene diphenyl di-isocyanate (pMDI).

An additional drawback of all these above-mentioned glues is that they are based on fossil raw materials.

Bio-based glues for boards are already available, but the production of boards using these glues can be accompanied by drawbacks. Possible drawbacks include excessively low reactivity, uncontrolled/undesired prepolymerisation, limited adhesion strength, poor moistening properties, hydrolysis of the glue under the influence of water or high humidity. Examples of bio-based glues are glues based on lignin, plant flour such as soy flour, or sugars.

The present invention concerns in the first place the preparation of an alternative board comprising cellulose-containing materials and a glue, and a method for forming such alternative boards, wherein in accordance with various embodiments, solutions are provided for the problems with such boards and glues used from the prior art.

The invention relates to a board comprising cellulose-containing materials, such as vegetable fibres and/or wood chips and/or wood pieces, and a cured glue that bonds these cellulose-containing materials to one another, wherein the cured glue is obtained by the curing of a glue that is a combination of at least one protein-containing fraction and a second fraction, wherein the second fraction comprises molecules selected from the list of: amino acids, peptides, polyamines comprising amino acids, polyamides comprising amino acids, and optionally polyimines (for example polyethyleneimine). The peptides are for example oligopeptides and/or polypeptides.

Another term for protein is protein, such that the protein-containing fraction can also be referred to as the protein-containing fraction. This protein-containing fraction comprises proteins, wherein these proteins for example account for at least 10 wt %, preferably at least 20 wt %, even more preferably at least 30 wt % of the dry matter of the protein-containing fraction. This protein-containing fraction can comprise proteins of vegetable origin and/or proteins of animal origin. Preferably, this protein-containing fraction is flour-based. This means that the protein-containing fraction is a flour-based fraction that for example can comprise one or more unprocessed flours, but that can also comprise one or more processed flours, which refers to flours that have undergone one or more processing steps, such as denaturation and/or fermentation and/or the removal of one or more components from the flour. It is important in this context that the processed flour still comprises proteins. A protein-containing fraction based on flour refers to a fraction of which the dry matter substantially consists of flour and/or processed flour, for example at least 50 wt % of flour and/or processed flour based on the total weight of the dry matter, preferably at least 70 wt %, even more preferably at least 80 wt % and most preferably at least 90 wt %. Flour is a powder obtained by grinding grains, roots, beans, nuts, seeds, etc. In order to form the protein-containing fraction, components such as bran can be (partially) removed prior to and/or during and/or after grinding.

The above-mentioned molecules of the second fraction can for example comprise peptides. Peptides are molecules comprising a number of amino acids bonded to one another by peptide bonds. A peptide can be composed of various types of amino acids or can be composed of one same type of amino acids. The above-mentioned molecules can also comprise polyamines and/or polyamides and/or polyimines. When amino acids are used for the preparation of polyamines and/or polyamides and/or polyimines, polyamines comprising amino acids and/or polyamides comprising amino acids and/or polyimines comprising amino acids are obtained. Polyamides and/or polyamines and/or polyimines that are composed primarily of amino acids, and which therefore are built up primarily from amino acids, can also be referred to as polypeptides, and this designation is preferred if the amino acids are bonded in linear fashion. Preferably, one works with polyamides and/or polyamines and/or polyimines that are built up from amino acids, wherein the polymerisation does not take place focused on one functional group. Such polyamides and/or polyamines and/or polyimines are referred to as hyperbranched. The above-mentioned molecules of the second fraction can also be selected only from the list of: amino acids and peptides. In this manner, the above-mentioned molecules can comprise peptides only, the above-mentioned molecules can comprise amino acids only, or the above-mentioned molecules can comprise amino acids and peptides only. These peptides then comprise for example oligopeptides and/or polypeptides, wherein these polypeptides may or may not comprise hyperbranched polypeptides. The second fraction then comprises for example peptides, wherein the peptides preferably account for at least 90 wt % of the dry matter of the second fraction. Preferably, the second fraction comprises no or substantially no proteins, and the protein content of the second fraction, which refers to the dry matter weight ratio of the proteins to the total weight of dry matter, is less than 0.03, preferably less than 0.01.

The dry matter of the protein-containing fraction preferably comprises at least 10 wt % of proteins, even more preferably at least 20 wt % of proteins and most preferably at least 30 wt % of proteins. The dry matter of the second fraction preferably comprises at most 5 wt % of proteins, even more preferably at most 1 wt % of proteins and most preferably no proteins. The glue is obtained by combining at least the protein-containing fraction and the second fraction.

The protein content of the protein-containing fraction, based on dry weight, is preferably greater than 20 wt %, and this is in order to ensure that there are sufficient proteins present. For example, the protein content can thus be between 20 and 80 wt %, for example between 30 and 60 wt %. If the protein-containing fraction is based on flour, then this fraction also comprises other components that can affect the properties of the glue, such as for example carbohydrates.

Surprisingly, it was found that a glue that is a combination of at least the above-mentioned protein-containing fraction and the above-mentioned second fraction has particularly favourable adhesion strength and is highly suitable for bonding cellulose-containing materials with one another to form boards. In addition, boards in accordance with the invention can show better technical properties than existing boards that are glued with existing aminoplast polymer glues, such as conventional urea formaldehyde glues. In this manner, greater stiffness (N/mm²) and transverse tensile strength (N/mm²) are obtained and/or greater water resistance. This therefore concerns highly stable, strong boards, which in addition retain at least the same water resistance as the above-mentioned existing boards. For example, in a board wherein the dry matter weight ratio of the glue to cellulose-containing materials, such as wood chips, is at least 8 wt % and which has a density greater than 700 kg/m³, at least the following values can be achieved:
Transverse tensile strength (in accordance with EN 319): 0.80 N/mm²
Bending strength (in accordance with EN 310): 17.5 N/mm²
Young's Modulus (in accordance with EN 310): 2850 N/mm²
Boiling test after 2 h (in accordance with EN 1087-1): 0.05 N/mm² transverse tensile strength

In addition, the production of boards in accordance with the invention can take place in a similar manner as the production of such boards with conventional urea formaldehyde glues (UF glues). One can then also switch to a glue that is a combination of at least the above-mentioned protein-containing fraction and the above-mentioned second fraction, and this without modifying the production process to an excessive degree. These boards are for example obtained by first providing the cellulose-containing materials with the glue and then pressing these cellulose-containing materials provided with the glue into a board-shaped material, wherein this board-shaped material for example is sawn into boards or already forms a board with the desired dimensions. The pressing preferably takes place at an elevated temperature, wherein this temperature can be increased to over 200° C.

During the production of these boards, the glue will undergo curing, and this is because the above-mentioned molecules of the second fraction, and more specifically the functional groups of the second fraction, will react e.g. with the proteins present in the protein-containing fraction and with any other molecules, more specifically the functional groups, in the protein-containing fraction. If the protein-containing fraction is based on flour, then the proteins and the carbohydrates of the protein-containing fraction will react e.g. with the above-mentioned molecules of the second fraction, but the various components of the protein-containing fraction will also react with one another. By means of this second fraction, a glue can therefore be obtained based on flour, thus being for example a glue comprising more than 50 wt % of flour that is highly suitable for forming boards comprising cellulose-containing materials. Preferably, the protein-containing fraction reacts with the second fraction only on addition of energy, for example by the addition of heat. For the production of the above-mentioned boards, the glue is combined with the cellulose-containing materials, after which the whole combination is normally pressed into boards and the glued cellulose-containing materials are exposed in this manner to pressure and heat. Such glue is then also highly suitable for forming boards. Prior to addition of the glue to the cellulose-containing materials, the protein-containing fraction can already have partially reacted with the second fraction, and this is in order to accelerate the curing. The curing preferably comprises polymerisation, but need not be limited to polymerisation.

The protein-containing fraction and the second fraction are two separate fractions that are combined to form the glue. The protein-containing fraction can also comprise peptides and/or amino acids. Preferably, the protein-containing fraction is based on flour. The second fraction then provides (additional) amino acids and/or peptides and/or polyamines and/or polyamides that are capable of reacting with both processed and unprocessed flour, so that a glue with better properties is obtained than would be the case if the glue only comprised the protein-containing fraction.

This glue does not need to contain formaldehyde, and this glue preferably comprises no formaldehyde, so that this glue has no additional adverse effect on any emissions of formaldehyde.

The content of the above-mentioned molecules in the second fraction, based on dry weight, is preferably greater than 70 wt %, even more preferably greater than 80 wt % and most preferably greater than 90 wt %. In this manner, the above-mentioned molecules of the second fraction can be produced for example from amino acids and/or obtained by the splitting of proteins, and thus comprise peptides and the like, wherein optionally other molecules are also present in the second fraction that for example have contributed to the production of the amino acids and/or the above-mentioned molecules. In this case, it is not necessary for the dry matter of the second fraction to comprise only the above-mentioned molecules, but this is possible. The presence of amino acids, oligopeptides or polypeptides also ensures that the formaldehyde released from hemicellulose, cellulose or lignin during the process of drying and pressing the wooden board material is chemically bound, for example by a nucleophilic end group. These amino acids, oligopeptides or polypeptides also serve as formaldehyde scavengers. By using this glue, the level of formaldehyde emissions can be reduced. The dry weight ratio of the above-mentioned molecules of the second fraction to the protein-containing fraction is for example between 0.03 and 0.82, preferably between 0.11 and 0.66. The dry matter of the glue comprises, based on weight, for example between 5 and 45 wt % of the above-mentioned molecules of the second fraction, preferably between 10 and 30 wt % and/or the dry matter of the glue comprises, based on weight, for example between 12 and 76 wt % of proteins, preferably between 14 and 64 wt % of proteins, wherein further preferably the wt % of proteins is always greater than the wt % of the above-mentioned molecules of the second fraction and wherein preferably the proteins originate only from the protein-containing fraction.

In order to form this board, a glue is used that is obtained by combining the above-mentioned protein-containing fraction and second fraction, wherein this glue therefore comprises the above-mentioned protein-containing fraction and the above-mentioned second fraction, and wherein this protein-containing fraction and second fraction may or may not already have partially reacted with each other, but this glue is not yet or at least not yet completely cured, so that this glue is usable for forming the board. During forming of the board, this glue will (further) undergo curing in order to obtain a cured glue that bonds the cellulose-containing materials to one another. Here, the term cured glue refers to a glue that has undergone curing during formation of the board, is sufficiently dry, and sufficiently bonds the cellulose-containing materials to one another in order to obtain the desired board. This does not mean that the glue is completely cured per se. In this case, a cured glue may or may not be a completely cured glue. In the above-mentioned boards, such as fibreboards, particle boards, OSB boards, multiplex boards, etc., heat can be generated and/or applied during production, for example during the pressing of these boards. By means of this heat, the reaction between the protein-containing fraction and the second fraction can be (further) promoted, and thus the glue used can (further) undergo curing. Here, a cured glue originating from a glue refers to the glue that results after curing of the glue used in order to form the boards.

The glue used in order to form this board is obtained by combining the protein-containing fraction and the second fraction. This means that this protein-containing fraction and this second fraction are provided when forming the glue. The protein-containing fraction and/or the second fraction can already comprise water or a solvent and in this manner form an aqueous solution or a solvent-containing solution. It is also possible that the protein-containing fraction and/or the second fraction occurs as a solid substance, for example in powder form. In combining the protein-containing fraction and the second fraction, additional water or another solvent may optionally be added. Percentages, weight percentages, amounts, and ratios are always expressed in the preceding and the following based on the dry matter amounts provided for forming of the glue, unless otherwise indicated. This is because in forming of the glue, it is possible that the protein-containing fraction and the second fraction have already (partially) reacted with each other prior to the use of the glue to form the boards. This is also because the glue comprises a certain amount of water or another solvent that dissipates during curing of the glue and therefore contributes only to the gluing but is not present in the final cured glue. Amounts of cellulose-containing materials are preferably expressed as dry-matter-cellulose-containing materials, i.e. dry cellulose-containing materials, for example dry wood.

This glue can be completely bio-based. In this manner, the protein-containing fraction can for example be produced from vegetable flour, and the second fraction can be obtained from amino acids that are created by a biological route, for example via bacteria, and/or from the splitting of vegetable/animal proteins into peptides, wherein these vegetable proteins for example are obtained from a flour.

In a preferred embodiment, the protein-containing fraction comprises proteins that are present in their primary, secondary or tertiary structure, wherein preferably at least 80 wt % of the proteins are present in their primary, secondary or tertiary structure, even more preferably at least 90 wt %, even more preferably at least 95 wt % and most preferably at least 99 wt %. The proteins in this protein-containing fraction can occur in their primary structure and/or in their secondary structure and/or in their tertiary structure. The presence of proteins in their quaternary structure is not excluded, but it is preferable that no or virtually no proteins are present in their quaternary structure. In the quaternary structure, the reactive groups of the protein are shielded. In the tertiary structure, there are already fewer shielded reactive groups, in the secondary structure there are even fewer shielded reactive groups, and in the primary structure all of the reactive groups are readily accessible. The reactivity of the glue is also higher the more proteins are in their primary, secondary or tertiary structure. The proteins can be present in their primary and/or secondary and/or tertiary structure due to denaturation and/or fermentation. In denatured proteins, at least the quaternary structure is unfolded to the tertiary structure, and even the secondary or primary structure can be present, causing the reactivity of the protein-containing fraction to be high. Due to fermentation, for example if the protein-containing fraction comprises fermented plant flour or is based on fermented plant flour, proteins in their quaternary structure may be unfolded to their tertiary structure, even to their secondary structure or even to their primary structure, which allows more functional groups of the protein to be chemically active. Preferably, the proteins are only unfolded to their tertiary, secondary or primary structure, and there is therefore no splitting of proteins into smaller molecules. The purpose of the denaturation and/or fermentation of a flour in order to obtain the protein-containing fraction is to unfold the present proteins to their tertiary, secondary or primary structure, so that they become more chemically active. However, a portion of the proteins may also be split into smaller molecules.

Preferably, use is made of only one first type of glues to form the boards, namely glues obtained by combining at least one above-mentioned protein-containing fraction and one above-mentioned second fraction, but the boards can also comprise other types of glues. In this manner, one can use a glue mixture comprising the first type of glue and one or more other types of glues, and/or the board can have multiple layers, wherein for a specified layer the first type of glue is used and for another specified layer another type of glue is used. Examples of other glues include conventional UF glues, MUF glues, MUPF glues, pMDI glues, polyurethane glues, polyvinyl butyral glues, polyacrylate glues, etc. Polyurethane glues can be used for example in order to increase water resistance and/or flexibility. It is also possible for a board to be formed with various glues of the first type. In this manner, the board can have multiple layers, wherein various glues, including for example all glues obtained by combining an above-mentioned protein-containing fraction and an above-mentioned second fraction, are used for the various layers. The latter various glues can differ in a wide variety of ways. The following is a non-exhaustive list of possible differences, wherein these differences may be combined with one another provided that they do not conflict: dry matter content, additives-types and amounts-, proteins-types and amounts-, any carbohydrates-types and amounts-, the above-mentioned molecules of the second fraction-types and amounts-, solvent used (water or solvent), etc.

In a highly preferred embodiment, the protein-containing fraction is obtained from one or more flours, wherein this protein-containing fraction for example comprises a denatured and/or fermented flour. When the protein-containing fraction comprises a denatured and/or fermented flour, this protein-containing fraction then contains respective denatured proteins and/or proteins after fermentation. Flour is bio-based, and in addition, one can opt for a flour that is unsuitable or less suitable for human or animal consumption. Flours also comprise components that can contribute to favourable adhesion strength. In this manner, flours also comprise a certain amount of carbohydrates. These carbohydrates can for example react with the above-mentioned molecules of the second fraction in accordance with the Maillard reaction. The Maillard reaction is the collective term for a complex series of chemical reactions that occur between reducing sugars and amines.

When the protein-containing fraction comprises a denatured and/or fermented flour, additives are then preferably added to this protein-containing fraction in order to improve the properties of this protein-containing fraction. In this manner, one can for example add glycerol (glycerine) or another triol in order to obtain the desired viscosity and/or stabilise the viscosity. By means of glycerol (glycerine), the viscosity of the protein-containing fraction can be kept stable over a lengthy period, several days to several weeks. In this manner, for example, 0.2 to 10 wt % of glycerol can be added to the dry matter flour. Additionally or alternatively, for glycerol, one can also use defoaming agents and/or anti-foaming agents. Examples of possible defoaming agents and/or anti-foaming agents are for example silane-based defoaming agents or oil-based defoaming agents. In this manner, for example up to 0.4 wt % of defoaming agents and/or anti-foaming agents can be added, for example 0.1 or 0.2 wt %, with respect to the dry matter flour. The protein-containing fraction then comprises, in addition to the denatured and/or fermented flour, additives and further optionally a solvent or water and/or chemicals used for the denaturation.

The protein-containing fraction is for example obtained from one or more flours, wherein this protein-containing fraction for example comprises one or more denatured and/or fermented flours, and wherein further preferably the protein content, i.e. the wt % of protein based on the total weight of dry matter, of the protein-containing fraction is at least half of the protein content of the one or more respective flours. Preferably, during denaturation and/or fermentation of a flour to form the protein-containing fraction, there is no or virtually no splitting of proteins into smaller molecules, so that the average molecular weight of the protein-containing fraction is high.

In a specific embodiment, the protein-containing fraction comprises a denatured flour, wherein this denatured flour is obtained by denaturation under the influence of heat and/or acidity and/or enzymes and/or addition of chemicals, wherein these chemicals are preferably selected from the group comprising: urea, guanidine, sulphates, sulfoxides, sulfonates, propylene glycol, sodium bisulphite. The protein-containing fraction can for example be a denatured flour that is optionally dissolved in water or a solvent. The term denaturation under the influence of acidity may refer to denaturation under the influence of a basic environment or denaturation under the influence of an acidic environment. Denaturation can take place under the influence of several of the above-mentioned factors: heat and/or acidity and/or enzymes and/or chemicals. In this manner, a combination can be used of for example optional heat, an acidic/basic environment and chemicals, or a combination of optional heat, an acidic/basic environment and enzymes, or a combination of heat, an optional acidic/basic environment and chemicals, or other combinations. The major advantage of this specific embodiment is that the denaturation can be controlled in a highly targeted manner, and thus one can determine the amount of proteins that occur in a specified structure, e.g. the content of proteins in the primary structure, the content of proteins in the secondary structure, the content of proteins in the tertiary structure and the content of proteins in the quaternary structure, so that a glue and therefore a board with the desired properties can be obtained. In chemical denaturation, wherein the above-mentioned chemicals are used, both the degree of denaturation and the acidity (pH) can be kept under control, wherein the solubility of the plant flour can be increased. Depending on the factors used for denaturation, an additional purification step may or may not be necessary. In this manner, for example, a flour can be placed in an aqueous environment (or in a solvent) comprising specified chemicals, for example urea and/or sodium bisulphite, after which denaturation takes place, optionally with further addition of heat and/or acids/bases. The result is a denatured flour in water (or in a solvent), that if necessary can already form the protein-containing fraction. Optionally, an additional purification step can take place. In this purification step, for example, certain of the above-mentioned chemicals can be removed and/or the water/solvent can (partially) be removed. In the denaturation, for example, one can use sodium dodecyl sulphate and/or sodium dodecyl sulfonate and/or dimethyl sulfoxide. These additives then serve as defoaming agents/anti-foaming agents. Optionally, whether or not in addition to the purification step, the above-mentioned additives and/or one or more of glycerol and/or other defoaming agents/anti-foaming agents can be added in order to obtain a stable protein-containing fraction. One can use a single denatured flour, but the protein-containing fraction can also be a mixture of several denatured flours. Preferably, the denaturation factors are therefore selected such that as few proteins as possible are split into smaller molecules, so that the proteins therefore are chiefly unfolded only to their tertiary, secondary or primary structure. Preferably, the protein-containing fraction comprises at least 40 wt % of dry matter, for example 45 wt % of dry matter, based on a denatured flour.

In a specific embodiment, the protein-containing fraction comprises a fermented flour, wherein this fermented flour for example is fermented by at least the addition of an amount of already-fermented flour. The protein-containing fraction can for example be a fermented flour that is optionally dissolved in water or a solvent. The fermentation can take place under anaerobic conditions for a number of hours, for example 2, 4, 8, 12, 25 or 36 hours, and for example at temperatures of between 20° C. and 40° C. The fermentation can take place using lactic acid bacteria, yeasts or moulds. One can optionally carry out pre-fermentation/pre-digestion, wherein a mixture of flour, water and optionally a small amount of lactic acid bacteria, yeasts or moulds is placed in a cool environment, and after this, further fermentation is allowed to proceed in a warmer environment. One can use a single fermented flour, but the protein-containing fraction can also be a mixture of several fermented flours. In order to allow the fermentation to take place, for example, water can be added. The result is then a fermented flour in water that optionally can already form the protein-containing fraction. Optionally, an additional purification step can take place. Optionally, whether or not in addition to the purification step, for example, one or more of glycerol or (the above-mentioned) defoaming agents/anti-foaming agents are added in order to obtain a stable protein-containing fraction. The advantage of working with fermented flour is that it has a favourable solubility in water. Fermented flour has a solubility of between for example 30 and 50%, which allows between 300 g and 500 g of fermented flour to dissolve in water to a 1 litre suspension and/or dispersion. This allows the water content of the glue to be relatively low, for example between 30 and 70 wt % of water, preferably between 30 and 50 wt %, based on the total weight of the glue, such that during the curing it is not always necessary for large amounts of water to vaporize, the formation of boards does not require too much energy, and during pressing under pressure and at high temperature the vapor pressure in the middle part of the board remains low (preferably below 300 kPa, preferably below 200 kPa). Preferably, the protein-containing fraction comprises at least 45 wt % of dry matter, for example 50 wt % of dry matter, based on a fermented flour.

In a specific embodiment, the protein-containing fraction comprises at least one denatured flour and at least one fermented flour. This makes it possible to obtain a protein-containing fraction with the desired properties.

In an embodiment, the protein-containing fraction comprises a fermented and denatured flour, i.e. a flour that has undergone both denaturation as for example described above and fermentation as for example described above, wherein preferably the fermentation takes place first, followed by the denaturation. It is also possible to carry out denaturation first followed by fermentation. It is also possible for denaturation and fermentation to take place at least partially simultaneously. This allows a protein-containing fraction to be obtained having the desired properties. The protein-containing fraction can for example be a denatured and fermented flour that is optionally dissolved in water or a solvent.

In a highly preferred embodiment, the protein-containing fraction is obtained from one or more flours, wherein a specified flour is preferably made of plants of the legume family, preferably plants of the group comprising: guar plant, pea plant, soy plant and plants of the genus Lupinus. Here, the protein-containing fraction can be completely bio-based. For example, one can use guar flour, wherein this guar flour is probably a residual product resulting from the production of gum from guar seeds. In order to obtain guar gum from guar seeds, the guar seeds are for example ground into flour, after which this flour is treated in order to substantially remove the guar gum. In this case, the resulting residual byproduct is referred to as guar flour. Of course, one can also use guar flour from which the guar gum has not been removed, wherein the guar flour is then ground guar seeds. As the nutritional value of guar flour, wherein this guar flour may or may not be the above-mentioned residual byproduct, is limited, it is advantageous to use this guar flour as glue. In addition, this guar flour, even if it is the above-mentioned residual byproduct, does contain a certain amount of guar gum, which contributes to the favourable adhesion strength of the glue. One can also use soy flour or lupine flour. Other flours not originating from plants of the legume family, such as for example rapeseed flour and wheat flour, are also usable for the protein-containing fraction.

Preferably, the above-mentioned molecules of the second fraction comprise amino acids selected from the group comprising: arginine, glutamine, asparagine, lysine, serine, threonine and alanine. These are amino acids that are simple to produce and can be produced by biological means. The second fraction can for example comprise peptides formed from these produced amino acids, for example the second fraction can comprise only the above-mentioned molecules that are composed of these simple-to-produce amino acids, wherein this second fraction then comprises only amino acids and/or peptides composed of amino acids selected from the above-mentioned group. It is also possible for the above-mentioned molecules to comprise additional peptides obtained by the splitting of proteins, and this second fraction can therefore optionally also comprise other amino acids not belonging to the above-mentioned group. This second fraction can therefore be completely bio-based. The above-mentioned molecules comprise for example peptides, such as oligopeptides, polypeptides and branched peptides. In this manner, the above-mentioned molecules can comprise polylysine or hyperbranched polylysine. Separate amino acids can be formed into peptides by condensation. In this manner, the amino acids can be hydrolysed to peptides by fermentation and/or chemical means and/or enzymatic means. Bacteria such as Corynebacterium (gram-positive) or Escherichia coli (gram-negative) can via fermentation substantially form lysine and for example a small amount of glutamine and/or any other amino acids.

In a specific embodiment, the above-mentioned molecules of the second fraction comprise hyperbranched polyamides. The above-mentioned molecules can thus comprise hyperbranched polylysine. Hyperbranched polyamides can react well with the proteins and any carbohydrates in the protein-containing fraction. Hyperbranched polyamides are also capable of adhering to formaldehyde, for example binding it chemically via addition reactions, which allows any emission of formaldehyde from the boards to be kept extremely low. In forming the boards, one can for example use materials comprising recycled cellulose, such as for example recycled refined particle boards. These recycled refined particle boards may comprise a certain amount of formaldehyde. The use of hyperbranched polyamides ensures that even when one works with recycled material, the emission of formaldehyde is not too high.

Hyperbranched polyamides are highly branched three-dimensional macromolecules. Hyperbranched/highly branched means that the polyamides are not linear and also indicates that there are a significant number of branches. This means that more than 3, preferably more than 5 and even more preferably more than 10 branches are present in the polyamide macromolecule. Such polyamides can be bio-based. The hyperbranched polyamides can for example be based on polycondensed amino acids, wherein these amino acids are produced for example using bacteria. When the hyperbranched polyamides are based on polycondensed amino acids, it is not necessary for them to be based on only one type of amino acid. When bacteria are used that for example primarily form lysine and a small amount of other amino acids such as glutamine, both the lysine and any other amino acids can be used for the production of the hyperbranched polyamides, obviating the need for an additional purification step of the amino acids and allowing the production of the hyperbranched polyamides to take place in an ecological manner.

In a preferred embodiment, the above-mentioned hyperbranched polyamides are obtained by polycondensation of amino acids, wherein these amino acids are preferably selected from the group comprising arginine, glutamine, asparagine and lysine. The hyperbranched polyamides are obtained via peptide bonds, wherein no preference is given to functional groups of the amino acids. In order to form these hyperbranched polyamides, one can opt to block no or virtually no groups or positions of the amino acids. In this manner, one can opt not to block the a-position and/or the E-position of the amino acids. The hyperbranched polyamides are for example primarily obtained by the polycondensation of lysine. Lysine is a basic amino acid that is cationic in a neutral medium. Lysine is for example obtained via fermentation using bacteria such as Corynebacterium or Escherichia coli. During the production of lysine, smaller amounts of other amino acids, such as glutamine, can also be formed. By selecting the bacteria, the nutrients and the fermentation conditions, the desired amino acids can be formed in a targeted manner. Several carbohydrate sources can be used for this fermentation, such as sucrose, glucose, cellulose, hemicellulose or lignin. As an ammonia source for the fermentation, mixtures of ammonium salts, such as ammonium sulphate or diammonium phosphate, are often used. Ammonium sulphate can be obtained as a byproduct in manure processing or after stripping of ammonia-containing gases. In other words, the production of amino acids such as lysine can completely or substantially take place based on bio-based raw materials and/or waste materials. Polycondensation of the amino acids to hyperbranched polyamides can for example take place using extrusion. In this manner, one can for example use reactive extrusion (REX). With REX, for example, the amino acids are placed in an extruder. These amino acids can be placed in the extruder in powder form. The amino acids can also be placed in the extruder in liquid form. These amino acids comprise for example at least 90 wt % of lysine. By means of extrusion, hyperbranched polyamides can be formed in a rapid and efficient manner. The advantage of an extruder is that the temperature and/or pressure in the various zones of the extruder can be optimized. In extrusion, one may also simply add other chemicals, such as for example additives and/or crosslinkers, in order to accelerate and/or control the polycondensation. It is also possible to easily carry out degassing using an extruder. The degree of polymerisation of the obtained hyperbranched polyamides can thus also be kept sufficiently homogeneous. This is also a stable process, so that hyperbranched polyamides can be produced in a uniform manner. The production conditions can also be adapted to the desired hyperbranched polyamides to be obtained. By means of extrusion, customized hyperbranched polyamides can also be formed.

In a specific embodiment, the hyperbranched polyamides have an average molecular weight of between 500 and 100000 g/mol, for example between 5000 and 50000 g/mol, or for example between 10000 and 25000 g/mol. The reactivity of the hyperbranched polyamides is optimal if the average molecular weight is greater than 5000 g/mol, and the gluing can be carried out quite favourably when the average molecular weight is less than 50000 g/mol. Preferably, 90 wt % of the hyperbranched polyamides, even more preferably 95 wt %, and most preferably 99 wt %, have a molecular weight that is greater than 20000 g/mol. This also allows favourable production of the boards. The average molecular weight of hyperbranched polyamides can be determined for example by low angle laser light scattering (LALLS). Alternatively or additionally, the average molecular weight can be determined by gel permeation chromatography (GPC). Throughout this patent application, the average molecular weight is preferably the number-average molecular weight.

In a specific embodiment, the hyperbranched polyamides account for at least 1 wt %, preferably at least 3 wt % and most preferably at least 5 wt % of the dry matter of the second fraction and/or the hyperbranched polyamides account for at most 50 wt %, preferably at most 40 wt % and most preferably at most 30 wt % of the dry matter of the second fraction.

In a highly preferred embodiment, the dry matter of the second fraction comprises at least 30 wt % of peptides, preferably at least 50 wt % of peptides, even more preferably at least 30 wt % of oligopeptides and most preferably at least 50 wt % of oligopeptides. Peptides, and certain oligopeptides, are reactive molecules.

In a specific embodiment, the second fraction is obtained from one or more flours, at least by splitting the proteins present in these flours into peptides, wherein the protein content, i.e. the wt % of proteins based on the total weight of dry matter, of the second fraction is preferably at most 10 wt %, even more preferably at most 5 wt % and most preferably at most 1 wt %. In this case, the above-mentioned molecules of the second fraction are obtained by the splitting of proteins into smaller molecules. In this manner, one can for example first extract the proteins from a flour, after which these proteins are then split. The latter process can be carried out for example enzymatically using proteases and/or hydrolysis.

Preferably, the dry matter weight ratio of the second fraction to the total of the protein-containing fraction and the second fraction is between 0.05 and 0.45, preferably between 0.10 and 0.30, wherein the above-mentioned molecules of the second fraction preferably account for at least 90 wt % of the dry matter of the second fraction. The protein-containing fraction then constitutes the largest fraction. If the protein-containing fraction comprises a denatured and/or fermented flour, the dry matter weight ratio of the second fraction to the total of this denatured and/or fermented flour is then for example between 0.05 and 0.45, preferably between 0.10 and 0.30. We are speaking here of the dry matter weight ratio, as the glue can also comprise a certain amount of water or another solvent.

In a specific embodiment, the board comprises one or more layers, wherein at least one above-mentioned layer comprises the above-mentioned cellulose-containing materials and the above-mentioned glue, wherein in this layer, the dry matter weight ratio of the glue to cellulose-containing materials is between 0.03 and 0.15, preferably less than 0.10. If the board comprises several layers, not all layers need comprise the same glue. Therefore, if the board comprises two outer cover layers and one or more central layers, the cover layers and the central layers can comprise another glue. The above-mentioned ratio is also determined by the type of board; for example, in three-layer particle boards comprising a central layer and two outer cover layers, the percentage by weight of glue with respect to cellulose-containing materials in all layers is between 3% and 15%, wherein the percentages by weight for the cover layers are preferably higher than the percentage by weight of the central layer. In this manner, in the cover layers, the above-mentioned percentage by weight can be between 7 and 14, for example 6, 7, 8, 9, 10, 11 or 12. In the central layer, the above-mentioned percentage by weight can be between 3 and 10, for example 3, 4, 5, 6, 7 or 8. In MDF or HDF or OSB, this percentage by weight can be between 5 and 15, and therefore for example be 6, 7, 8, 9 or 10.

In a specific embodiment, an additional crosslinker for proteins, peptides or amino acids is added to form the glue. In this manner, for example, additional crosslinkers for proteins, peptides or amino acids are combined with the protein-containing fraction and the second fraction to form the glue. Classic crosslinkers are dialdehydes such as glutaraldehyde and succinaldehyde, but can also be polyfunctional polymers such as aldehyde dextran or aldehyde starch. Additional crosslinkers can be added in various amounts. Interaction with the second fraction and to a lesser degree with the protein-containing fraction will determine the choice and amount of the relevant crosslinker. Dialdehydes can for example be added to oligopeptides without disrupting the solubility and viscosity.

In a highly preferred embodiment, the glue comprises additives for optimising the glue properties, preferably for optimising the reaction between the proteins of the protein-containing fraction, any carbohydrates of the protein-containing fraction and the above-mentioned molecules of the second fraction. Here, in order to form the glue, the protein-containing fraction, the second fraction and the additives are combined. The protein-containing fraction and/or the second fraction can already comprise water or a solvent. The additives can also be added as an aqueous solution or as a solvent-containing solution. It is also possible for the protein-containing fraction and/or the second fraction and/or the additives to be in the form of a solid material, for example in powder form. When combining the protein-containing fraction, the second fraction and the additives, additional water or another solvent can optionally be added. Preferably, the dry matter weight ratio of the total of the protein-containing fraction and the second fraction to the total weight of the dry matter of the glue is at least 85 wt %, even more preferably at least 90 wt %. By means of the additives, the reaction between the proteins and any carbohydrates of the protein-containing fraction and the above-mentioned molecules of the second fraction can be optimised, for example accelerated/increased, and a board with improved properties can therefore be obtained. The additives can increase the reactivity of the glue and/or prevent undesirable prepolymerisation and/or ensure cold adhesion and/or increase the adhesion strength of the cured glue. The result is a board with the desired tensile strength, bending strength, modulus of elasticity, etc. The additives therefore provide a better glue. By means of this glue, one can opt to produce boards with better properties compared to boards produced using existing conventional urea formaldehyde-based glues. However, one can also opt to use less glue than in boards produced with urea formaldehyde-based glues and yet obtain similar properties.

These additives comprise for example cross-linkers, wherein these cross-linkers are preferably selected from the group comprising: polyketones, polyesters, isocyanate dispersions, epoxides, and dialdehydes. The dialdehydes comprise for example glutaraldehyde, succinaldehyde or aldehyde starch. Preferably, the dry matter weight ratio of the additives to the total of the protein-containing fraction and the second fraction is between 0.02 and 0.15. The cross-linkers can be selected for example from the group: a-hydroxy aldehydes, glyceraldehyde and a-dicarbonyls. These cross-linkers provide additional cross-linking between the various components of the glue, thus allowing a board with the desired properties to be obtained.

The glue can comprise one or more types of cross-linkers. During the pressing of the boards, these cross-linkers provide better and more rapid gluing between the cellulose-containing materials, so that the board obtained has the necessary stiffness and strength, and the bond between the cellulose-containing materials does not break undesirably. In addition, using these cross-linkers can further shorten the pressing time and improve the technical properties of the final product, such as a particle board, OSB or MDF. The technical properties are for example the bending strength, tensile strength, compression strength and water resistance. The above-mentioned cross-linkers are or comprise for example polyesters, wherein these polyesters are preferably dispersed and/or unsaturated polyesters. These unsaturated polyesters are for example highly branched, which makes them readily soluble and does not adversely affect the viscosity of the glue used for forming the boards. During the production of the boards, wherein pressing is used, the acidity of the polyesters is preferably adjusted or stabilised in the direction of the acidity of the polyamides, so that prior to pressing, no acid/base reactions, resulting in undesirable prepolymerisation, take place. For example, the above-mentioned cross-linkers are or comprise epoxides. Outstanding results are obtained using epoxides, such as di-epoxides or tri-epoxides or multi-epoxides or a combination of the various above-mentioned epoxides. These epoxides, for example the di-epoxides or the tri-epoxides, can for example comprise one or more oxirane end groups and preferably comprise two or more oxirane end groups. These epoxides can be created for example via bio-based routes from lignin or aniline, such as glycerol diglycidyl ether, and/or ethylene glycol diglycidyl ether. These epoxides can for example comprise diglycidyl ether of vanillyl alcohol and/or phloroglucinol tris epoxide. It is known that epoxides react with molecules comprising amino acids. In this case, however, it is exceptional that the above-mentioned molecules of the second fraction can be brought into in contact with epoxides without undesirable prepolymerisation after gluing of the cellulose-containing material and prior to pressing of the board.

These additives can comprise for example thickeners, such as galactomannans or gelling agents. The galactomannan can for example be guar gum. Other examples of thickeners include carboxymethyl cellulose or starch. Guar gum can also be present in the protein-containing fraction, if this protein-containing fraction is based for example on guar flour. However, additional guar gum can also be added in order to improve/modify the properties of the glue.

The additives may or may not actively participate in the reactions that take place during the curing of the glue and therefore may or may not be used.

During the production of the glue used to form the board, the various fractions of the glue are combined. This can or cannot take place in various steps.

In a specific embodiment, the protein-containing fraction comprises carbohydrates and the additives comprises additives for controlling the Maillard reaction, wherein these additives are preferably selected from the list of: bases—such as K₂CO₃—, salts of a hypochlorous acid-such as sodium hypochlorite (NaOCl)—, and metal-comprising component—such as metal oxides and/or metal hydroxides and/or metal salts-.

By means of bases, the pH during the Maillard reaction is controlled, and so is obtained that the desired Maillard reaction products are formed. Surprisingly, it was found that K₂CO₃ is a highly suitable base for use as an additive. K₂CO₃ is a base that causes a more rapid onset of the Maillard reaction, but does not cause undesirable prepolymerisation of the glue. Preferably, the bases also comprise K₂CO₃, and even more preferably, the bases comprise only K₂CO₃. The term prepolymerisation refers to the polymerisation of the glue, specifically for example before the forming, for example the pressing, of the board. The addition of K₂CO₃ does not cause an undesirable increase in the viscosity of the glue. Other bases, for example the strong bases NaOH and KOH, can also be used. The bases can also comprise Na₂CO₃ and/or Na₂HPO₄ or for example comprise only one of these above-mentioned bases. NaOH and KOH can cause undesirable prepolymerisation and thus result in boards with impaired technical properties, making them less suitable. It is also possible to use two or more different bases. Up to 5 wt % of K₂CO₃ can be present in/added to dry matter glue. Preferably, the protein-containing fraction and the second fraction are stored separately and are only combined when gluing is to be carried out. K₂CO₃ or other additives can be added to the protein-containing fraction and are therefore stored together. K₂CO₃ or other additives are added to the second fraction and can therefore be stored together. When an epoxide is also present, it is preferably added to the protein-containing fraction in order to be stored. Of course, the additives can also be stored separately and for example only be added shortly before gluing.

Salts of a hypochlorous acid promote the formation of Strecker degradation products during the Maillard reaction, making it possible to obtain boards with greater stiffness and/or boards with the same stiffness using less glue. Surprisingly, it was found that primarily sodium hypochlorite (NaOCl) has a positive effect. The salts of a hypochlorous acid therefore preferably comprise and even more preferably are NaOCl. Other examples of possible salts of a hypochlorous acid are potassium hypochlorite and calcium hypochlorite. It is also possible to use two or more different salts mentioned above.

The additives can also comprise crosslinkers that are preferably intermediate products arising in the Maillard reaction between amines and carbohydrates. Examples of such intermediate products are: α-hydroxy aldehydes, glyceraldehyde and α-dicarbonyls.

By means of metal-comprising components, polymerisation is strengthened and/or accelerated under the influence of heat, resulting in extremely high-strength boards.

The boards in accordance with the invention can not only be suitable for applications in dry indoor conditions (service class 1), but can also be suitable for more humid spaces, including humid indoor spaces such as bathrooms (service class 2). These boards can meet the currently effective specifications of the relevant European Standards EN 312, EN 300 or EN 622-5, wherein all product types can be obtained.

The invention also relates to a glue for the bonding of cellulose-containing materials, such as vegetable fibres and/or wood chips and/or wood pieces, to boards, wherein the glue is a combination of at least one protein-containing fraction and a second fraction, wherein the second fraction comprises molecules selected from the list of: amino acids, peptides, polyamines comprising amino acids, polyamides comprising amino acids and optionally polyimines. This glue is the glue used to produce boards as described above. The advantages and embodiments of the board described above with respect to the glue therefore also apply to this glue. The advantages and embodiments of this glue given below also apply to boards comprising this glue. Surprisingly, it was found that such a glue is highly suitable for gluing cellulose-containing materials, such as wood fibres or other vegetable fibres, wood chips, wood layers and wood shavings, to each other in order to form boards by pressing.

Here, the glue is a combination of the protein-containing fraction and the second fraction. This glue is therefore based on this protein-containing fraction and this second fraction. This means that in forming of the glue, one must provide this protein-containing fraction and this second fraction. Here, percentages, amounts, and ratios are always expressed based on the dry matter amounts provided for forming the glue. This is because in forming of the glue, it is possible that the protein-containing fraction and the second fraction may already have (partially) reacted with each other prior to use of the glue to form the boards.

Preferably, the protein-containing fraction comprises proteins that are present in their primary, secondary or tertiary structure, wherein preferably at least 80 wt % of the proteins are present in their primary, secondary or tertiary structure. The reactivity of the proteins is the highest when they are in their primary structure, because the higher the structure, the more the reactive groups are shielded and the more difficult it is to access them, thus making it more difficult for the proteins to react with the above-mentioned molecules of the second fraction. For example, by means of denaturation or fermentation, the quaternary structure of proteins can be unfolded to the tertiary, the secondary or the primary structure.

In a preferred embodiment, the protein-containing fraction comprises at least one flour, for example a denatured and/or fermented flour.

The embodiments and explanation with respect to denatured flour or with respect to fermented flour such as described for the board in accordance with the invention are also applicable to the glue. The denatured flour can thus be obtained by denaturation under the influence of heat and/or acidity (basic or acidic) and/or enzymes and/or the addition of chemicals, wherein these chemicals are preferably selected from the group comprising: urea, guanidine, sulphates, sulfoxides sulfonates, propylene glycol. Examples of chemicals are sodium dodecyl sulphate or sulfonate or dimethyl sulfoxide. Fermented flour can also be obtained by adding a certain amount of fermented flour to unfermented flour. Fermentation can for example take place under anaerobic conditions during periods of 8, 12, 24, 36 hours, for example at temperatures of between 20 and 40° C. One can use lactic acid bacteria, yeasts or moulds.

The protein-containing fraction can comprise fermented and denatured flours, which refers to flours that have undergone both the step of denaturation and the step of fermentation, wherein the step of fermentation preferably takes place first, followed by the step of denaturation.

The flour can be made of plants of the legume family, preferably plants of the group comprising: guar plant, pea plant, soy plant and plants of the genus Lupinus.

The above-mentioned molecules of the second fraction can comprise amino acids from the list of: arginine, glutamine, asparagine, lysine, serine, threonine and alanine.

Preferably, the second fraction comprises hyperbranched polyamides, wherein preferably the hyperbranched polyamides account for at least 1 wt %, even more preferably at least 3 wt %, and most preferably at least 5 wt %, or preferably at most 20 wt %, even more preferably at most 15 wt % or most preferably at most 10 wt % of the dry matter of the second fraction. The hyperbranched polyamides can comprise properties such as those described for the board in accordance with the invention. For example, the hyperbranched polyamides are obtained by polycondensation of amino acids, wherein these amino acids are preferably selected from the group comprising arginine, glutamine, asparagine and lysine.

The hyperbranched polyamides preferably have an average molecular weight of between 500 and 100000 g/mol, for example between 5000 and 50000 g/mol, and for example between 10000 and 25000 g/mol. The average molecular weight is preferably the number average molecular weight.

In a preferred embodiment, the dry matter of the second fraction comprises at least 30 wt % of peptides, preferably at least 50 wt % of peptides, even more preferably at least 30 wt % of oligopeptides and most preferably at least 50 wt % of oligopeptides.

Preferably, the dry matter weight ratio of the second fraction to the total of the protein-containing fraction and the second fraction is between 5 and 45 wt %, preferably between 10 and 30 wt %, wherein preferably the above-mentioned molecules of the second fraction account for at least 90 wt % of the second fraction.

In a preferred embodiment, the glue comprises additives for optimising the glue properties, preferably for optimising the reaction between the proteins of the protein-containing fraction, any carbohydrates of the protein-containing fraction, and the above-mentioned molecules of the second fraction, wherein preferably these additives comprise
cross-linkers, these cross-linkers for example being selected from the group comprising polyketones, polyesters, isocyanate dispersions, epoxides and dialdehydes and/or
thickeners, for example galactomannans or gelling agents and/or
additives for controlling the Maillard reaction.

These additives can have the same embodiments as the additives described for the board in accordance with the invention.

Preferably, the glue comprises water, wherein the water preferably accounts for between 40 and 70 wt % of the total weight of the glue. The glue can then for example be an aqueous solution or a dispersion.

The glue can comprise water as a solvent or as a dispersant. Alternatively, the glue can also be solvent-based. During the gluing of the cellulose-containing materials, the water ensures that the cellulose-containing materials are wet and even that there is slight penetration of the cell wall. By means of this glue, the cellulose-containing materials can be quite favourably bonded to one another, and this is due to the favourable contact between the glue and the cellulose-containing materials. By means of water, contact between the glue and the cellulose-containing materials is possible at the level of virtually the entire outer surface of the cellulose-containing materials.

The viscosity of the glue used for forming boards is preferably at most 20000 mPa.s, even more preferably at most 2000 mPa.s, at 20° C. and 1.013 bar.

The protein-containing fraction and the second fraction of the glue are preferably stored apart, so as to prevent reactions between the above-mentioned fractions, and this prior to use of the glue.

The invention also relates to a method for forming boards comprising cellulose-containing materials, such as vegetable fibres and/or wood chips and/or wood pieces, wherein cellulose-containing materials are provided and a glue is applied to these cellulose-containing materials, after which these cellulose-containing materials provided with glue are pressed into a board-shaped material in order to form boards, wherein the glue is a glue as described above. By means of this method, a board is obtained as described above. In this case, all advantages and embodiments described above for the board in accordance with the invention and the glue in accordance with the invention are also applicable to this method. Surprisingly, in this case, the pressing into boards can take place in the same manner as the pressing of cellulose-containing materials provided with glue into boards, wherein the glue is a conventional UF glue.

The cellulose-containing materials, such as for example wood chips, wood shavings, wood layers, wood fibres or other vegetable fibres, are provided with glue, i.e. glued, by for example atomizing/spraying/pouring glue onto these cellulose-containing materials. For this purpose, the cellulose-containing materials cab be located in an air flow or a mixer in order to glue the cellulose-containing materials as homogeneously as possible by means of atomization and/or mechanical friction. After this, the glued cellulose-containing materials are pressed together, for example in a continuous press or a discontinuous press, under a specified pressure, for example a pressure of between 2 and 6 N/mm², preferably between 2 and 4 N/mm², at a specified temperature, for example a temperature of between 160° C. and 245° C., preferably 200° C. and 245° C., and for a specified time, for example at least 4 sec per mm of board thickness. The glue will bond to the cellulose-containing materials and undergo curing in order to obtain a solid board. This glue can be a one-component glue, wherein the glue is stored in its entirety and applied in its entirety to the cellulose-containing materials. The glue can also be a two-component or multi-component glue, wherein the glue comprises two or multiple components that are stored separately, wherein these components are combined prior to gluing and thus applied as a single whole to the cellulose-containing materials or wherein these components are applied without first being combined to the cellulose-containing materials, and this process may or may not be simultaneous. These two or more components can then for example be the protein-containing fraction, the second fraction, and optionally, the above-mentioned additives. The additives can also be (partially) added to the protein-containing fraction or the second fraction in order to form a said component of the multi-component glue. In this manner, for example, undesirable prepolymerisation can be prevented.

In a specific embodiment, wherein the board comprises one or more layers, these layers are pressed together, and at least one of the above-mentioned layers comprises the above-mentioned cellulose-containing materials and the above-mentioned glue, wherein in this layer, the dry matter weight ratio of the glue to cellulose-containing materials is between 0.03 and 0.15, preferably between 0.04 and 0.1. The board can for example be composed of three or more layers, with outer cover layers and one or more central layers, wherein at least one central layer comprises the above-mentioned cellulose-containing materials and the above-mentioned glue, and wherein each of the cover layers comprises cellulose-containing materials and a glue as described above, wherein the weight ratio of the glue to cellulose-containing materials in the cover layers is greater than the weight ratio of the glue to cellulose-containing materials in the last-mentioned central layer.

In a preferred embodiment, the pressing takes place at a temperature of between 150° C. and 250° C., with a pressing force of between 1.5 and 5 N/mm², with the pressing time being at least 3 sec per mm of board thickness. For example, depending on the pressing temperature and the pressing type, the time can be 3 to 7 sec per mm of board thickness. Either a continuous or a discontinuous press can be used. In pressing, the surfaces are preferably sprayed above and below with water, for example between 10 and 50 g/m² of water, in order to promote heat transfer to the middle of the board and shorten the total pressing time.

In a specific embodiment, the cellulose-containing material is covered with glue by injection, atomizing or friction between the cellulose-containing materials or a combination of these techniques. In this manner, favourable gluing of the cellulose-containing material is achieved. This relates to similar or the same gluing that is applied when using common UF glues, with the result that an existing gluing step of an existing production process need not be applied or need be applied in only a slightly limited manner to the glue in accordance with the invention.

This invention also relates to a method for the preparation of a glue for boards, wherein a protein-containing fraction and a second fraction are provided, wherein the second fraction comprises molecules selected from the list of: amino acids, peptides, polyamines comprising amino acids, and polyamides comprising amino acids, and wherein the protein-containing fraction and the second fraction are combined. If the glue comprises the above-mentioned additives, these additives are then also added.

An alternative embodiment of the invention relates to a glue for the bonding of insulation materials, such as glass wool, rock wool, etc., for example to mats, wherein the glue is a glue as described above. The preferred embodiments of the glue as described above also apply to this alternative embodiment. By means of this glue, insulation material such as glass wool, rock wool, etc. is then formed. The invention also relates to an insulation material such as glass wool or rock wool comprising a glue as described above and also to a method for the preparation of an insulation material such as glass wool or rock wool, wherein a glue as described above is provided.

In order to better explain the features of the invention, several preferred embodiments are described below as examples that by no means limit the scope of the invention.

A first embodiment of a board in accordance with the invention is a 3-layer particle board comprising two outer cover layers and a central layer. The central layer comprises coarse wood chips that may or may not originate from wood waste and/or recycled particle boards, and the cover layers comprise finer wood chips. The wood chips are bonded to one another using a glue. The glue is a combination of a protein-containing fraction, a second fraction and additives. At least the protein-containing fraction, and preferably also the second fraction, are water-based, so the above-mentioned fractions can easily be combined.

The protein-containing fraction is based on flour, preferably a soy flour, a lupine flour, a wheat flour, a canola flour, a pea flour and/or a guar flour. In order to form the protein-containing fraction, this flour is denatured and/or fermented. If the protein-containing fraction is a denatured flour, then the denaturation preferably takes place using chemicals. One can therefore add (a part of) the flour to water which contains chemicals or to which chemicals are later added. These chemicals are for example one or more from the list of: urea, guanidine, dimethyl sulfoxide, sodium dodecyl sulphate, sodium dodecyl sulfonate and propylene glycol. If not all of the flour has yet been added, then the remainder of the flour may be added. As a last step, glycerol and/or defoaming agents/anti-foaming agents are added to reduce the viscosity and for stabilisation. The pH of the solution can be adjusted in order to maximise the solubility of the suspension/dispersion. The result is a stable protein-containing fraction. If the protein-containing fraction is a fermented flour, then this fermentation can take place by adding the flour to water and adding to this an amount of already-fermented flour and/or adding (further) lactic acid bacteria, yeasts or moulds. Based on dry weight, one can thus add between 5 and 10% fermented flour to unfermented flour.

The second fraction comprises at least 90 wt % of the above-mentioned molecules of the second fraction based on dry weight. These above-mentioned molecules of the second fraction comprise at least 50 wt % of oligopeptides and optionally between 1 and 10 wt % of hyperbranched polyamides, for example hyperbranched polylysine.

The additives optionally comprise cross-linkers and/or thickeners and/or additives for optimising the reaction between the protein-containing fraction and the second fraction. The additives can be added in an amount of 0.05 to 15 dry wt %. Examples of additives are glutaraldehyde, difunctional or trifunctional epoxides, dialdehyde starch, unsaturated polyesters or K₂CO₃. For example up to 5 wt % of K₂CO₃ can thus be added with respect to the total dry matter weight of the protein-containing fraction and the second fraction. The additives can be combined with the protein-containing fraction for temporary storage prior to the use of the glue.

A second embodiment of a panel in accordance with the invention is a fibreboard such as an MDF or HDF board. This fibreboard has a single layer and comprises wood fibres and a glue as described in the above paragraph.

The hyperbranched polyamides are obtained by polycondensation of amino acids that substantially comprise lysine. In addition to lysine, which is preferably L-lysine, for example, a small amount of glutamine may be present. Glutamine therefore accounts for example for at most 5 wt % of the amino acids present. The above-mentioned amino acids originate from a basic raw material comprising amino acids. This basic raw material is for example obtained by the fermentation of bacteria, wherein these bacteria form lysine in a targeted manner.

In the 3-layer particle board, the glue in the various layers is not necessarily the same glue. Since the cover layers of a wooden board material are heated more rapidly and for a longer duration, the maximum temperature in the cover layers is higher than in the middle of the board, and the moisture balance in the cover layers is different from the core, it is possible to reduce or adjust both the ratio of the second fraction and the amount of additives. Concerning the weight dosage of glue to wood, more glue is used in the cover layers than in the central layer. In this manner, one can be sure that the cellulose-containing materials in the cover layers will not unexpectedly come loose from one another. The use of more glue in the cover layers is not redundant, because cover layers are composed of finer particles, thus significantly increasing the total surface area to be glued.

In the following, several examples of formed boards will be given for illustrative purposes and the test results for these boards will be indicated. The boards are all boards obtained using the same press and pressing parameters. The following parameters are used, among others: pressing temperature 200° C., pressing time 120 sec. The board thickness is always 12 mm and the board is a three-layer particle board (cover layer, central layer, cover layer), wherein 66 wt % of the wood is located in the central layer and 34 wt % of the wood is proportionally distributed over the cover layers.

### Example 1:

The protein-containing fraction is a denatured soy flour dispersion formed adding soy flour in powder form to water. Chemicals are used for denaturation, wherein these chemicals were selected from the group of: sodium bisulfite, sodium dodecyl sulfonate benzene and urea. The weight ratio of soy flour powder to water can for example be between 0.4 and 0.7, the weight ratio of the above-mentioned chemicals to soy flour powder can for example be between 0.4 and 0.6. A dispersion is specifically formed by combining 250 g of water, 135 g of soy flour in powder form, 4 g of sodium bisulfite, 6 g of sodium dodecyl sulfonate benzene and 60 g of urea.

The second fraction comprises hyperbranched polylysine, preferably only hyperbranched polylysine dissolved in water.

For the central layer, the dry matter weight ratio of the glue to the total weight of wood chips is 0.08, wherein the protein-containing fraction accounts for 60 wt % of the glue and the second fraction accounts for 40 wt % of the glue.

For the cover layers, the dry matter weight ratio of the glue to the total weight of wood chips is 0.09, wherein the protein-containing fraction accounts for 65 wt % of the dry matter glue and the second fraction for 35 wt %.
This board has a transverse tensile strength (in accordance with E319): 0.31 N/mm²
Bending strength (in accordance with EN 310): 9.8 N/mm²
Modulus of elasticity (in accordance with EN 310): 1945 N/mm²

### Example 2:

The protein-containing fraction is the same as in Example 1. The second fraction comprises hyperbranched polylysine. For the central layer, the additive glutaraldehyde is used.

For the central layer, the dry matter weight ratio of the glue to the total weight of wood chips is 0.0825, wherein the protein-containing fraction accounts for 63 wt % of the dry matter glue, the second fraction for 34 wt % and the glutaraldehyde for 3 wt %.

For the cover layers, the dry matter weight ratio of the glue to the total weight of wood chips is 0.09, wherein the protein-containing fraction accounts for 65 wt % of the dry matter glue and the second fraction for 35 wt %.
This board has a transverse tensile strength (in accordance with E319): 0.40 N/mm²
Bending strength (in accordance with EN 310): 10.2 N/mm²
Modulus of elasticity (in accordance with EN 310): 2195 N/mm²

### Example 3:

The protein-containing fraction is the same as in Example 1. The second fraction comprises glycine.

For the central layer, the dry matter weight ratio of the glue to the total weight of wood chips is 0.08, wherein the protein-containing fraction accounts for 65 wt % of the dry matter glue and the second fraction for 35 wt %. The dry matter second fraction preferably comprises only glycine.

For the cover layers, the dry matter weight ratio of the glue to the total weight of wood chips is 0.09, wherein the protein-containing fraction accounts for 65 wt % of the dry matter glue and the second fraction for 35 wt %. The dry matter second fraction preferably comprises only glycine.
This board has a transverse tensile strength (in accordance with E319): 0.42 N/mm²
Bending strength (in accordance with EN 310): 11.0 N/mm²
Modulus of elasticity (in accordance with EN 310): 2105 N/mm²

### Example 4:

The protein-containing fraction is a denatured lupine dispersion obtained by adding lupine flour to water. Chemicals were used for denaturation, wherein these chemicals were selected from the group of: sodium bisulfite and urea. The weight ratio of lupine flour powder to water can for example be between 0.3 and 0.5, and the weight ratio of the above-mentioned chemicals to soy flour powder can for example be between 0.7 and 0.9. A first dispersion is specifically formed by combining 250 g of water, 100 g of lupine flour in powder form, 4 g of sodium bisulfite, and 80 g of urea. An alternative example of a specific dispersion is a dispersion formed by combining 175 g of water, 75 g of lupine flour in powder form, 4 g of sodium bisulfite, 75 g of urea and 15 g of glycerol.

The second fraction comprises polylysine.

For the middle layer, an epoxide is used as an additive.

For the central layer, the dry matter weight ratio of the glue to the total weight of wood chips is 0.0825, wherein the protein-containing fraction accounts for 58 wt % of the dry matter glue, the second fraction for 39 wt % and the epoxide for 3 wt %.

For the cover layers, the dry matter weight ratio of the glue to the total weight of wood chips is 0.09, wherein the protein-containing fraction accounts for 65 wt % of the dry matter glue and the second fraction for 35 wt %.
This board, with the first dispersion, has a transverse tensile strength (in accordance with E319): 0.52 N/mm²
Bending strength (in accordance with EN 310): 12.1 N/mm²
Modulus of elasticity (in accordance with EN 310): 2250 N/mm²

### Example 5

The protein-containing fraction is a fermented guar flour with a solid matter content of 50%. The guar flour originates from the production of gum from guar seeds.

The second fraction is composed of peptides originating from the hydrolysis of proteins. For the central layer, the dry matter weight ratio of the glue to the total weight of wood chips is 0.08, wherein the protein-containing fraction accounts for 65 wt % of the dry matter glue and the second fraction for 35 wt %.

For the cover layers, the dry matter weight ratio of the glue to the total weight of wood chips is 0.09, wherein the protein-containing fraction accounts for 78 wt % of the dry matter glue and the second fraction for 22 wt %.
This board has a transverse tensile strength (in accordance with E319): 0.65 N/mm²
Bending strength (in accordance with EN 310): 12.8 N/mm²
Modulus of elasticity (in accordance with EN 310): 2610 N/mm²

1-32. (canceled)

33. A board comprising cellulose-containing materials, such as vegetable fibers and/or wood chips and/or wood pieces, and a cured glue that bonds these cellulose-containing materials to one another,
wherein the cured glue is obtained by the curing of a glue that is a combination of at least one protein-containing fraction and a second fraction,
wherein the second fraction comprises molecules selected from the list of: amino acids, peptides, polyamines comprising amino acids, polyamides comprising amino acids and polyimines.

34. The board in accordance with claim 33, wherein the protein-containing fraction comprises proteins that are present in their primary, secondary or tertiary structure.

35. The board in accordance with claim 33, wherein the protein-containing fraction is obtained from one or more flours.

36. The board in accordance with claim 33, wherein the protein-containing fraction comprises a denatured flour,
wherein this denatured flour is obtained by denaturation under the influence of heat and/or acidity and/or enzymes and/or the addition of chemicals.

37. The board in accordance with claim 33, wherein the protein-containing fraction comprises a fermented flour.

38. The board in accordance with claim 33, wherein the molecules of the second fraction comprise amino acids selected from the group comprising: arginine, glutamine, asparagine, lysine, serine, threonine and alanine.

39. The board in accordance with claim 33, wherein the molecules of the second fraction comprise hyperbranched polyamides.

40. The board in accordance with claim 39, wherein the hyperbranched polyamides account for at least 5 wt % of the dry matter of the second fraction.

41. The board in accordance with claim 39, wherein the hyperbranched polyamides are obtained by polycondensation of amino acids.

42. The board in accordance with claim 33, wherein the dry matter of the second fraction comprises at least 30 wt % of peptides.

43. The board in accordance with claim 33, wherein the second fraction is obtained from one or more flours, at least by splitting the proteins present in these one or more flours into peptides, and
wherein the protein content, i.e. the wt % of proteins based on the total weight of dry matter, of the second fraction is at most 10 wt %.

44. The board in accordance with claim 33, wherein the dry matter weight ratio of the second fraction to the total of the protein-containing fraction and the second fraction, is between 0.05 and 0.45.

45. The board in accordance with claim 33, wherein the glue comprises additives for optimizing the glue properties,
wherein the additives comprise cross-linkers and/or thickeners and/or bases and/or salts of a hypochlorous acid and/or metal-comprising components.

46. A glue for the bonding of cellulose-containing materials, such as vegetable fibers and/or wood chips and/or wood pieces, to boards,
wherein the glue is a combination of at least one protein-containing fraction and a second fraction,
wherein the second fraction comprises molecules selected from the list of: amino acids, peptides, polyamines comprising amino acids, polyamides comprising amino acids and polyimines.

47. The glue in accordance with claim 46, wherein the protein-containing fraction comprises proteins that are present in their primary, secondary or tertiary structure,
wherein at least 80 wt % of the proteins are present in their primary, secondary or tertiary structure.

48. The glue in accordance with claim 46, wherein the protein-containing fraction comprises at least one flour, for example a denatured and/or fermented flour.

49. The glue in accordance with claim 46, wherein the second fraction comprises hyperbranched polyamides, and
wherein the hyperbranched polyamides account for at least 5 wt % of the dry matter of the second fraction.

50. The glue in accordance with claim 46, wherein the dry matter of the second fraction comprises at least 30 wt % of peptides.

51. The glue in accordance with claim 46, wherein the dry matter weight ratio of the second fraction to the total of the second fraction and the protein fraction is between 0.05 and 0.40.

52. The glue in accordance with claim 46, wherein the glue comprises additives for optimizing the glue properties,
wherein these additives are chosen from the list of: cross-linkers, thickeners or additives for controlling the Maillard reaction.
